(19) United States
(12) Patent Application Publication
(10) Pub. No.: US 2010/0267291 A1
(43) Pub. Date: Oct. 21, 2010

(54) SWAGING PROCESS FOR IMPROVED COMPLIANT CONTACT ELECTRICAL TEST PERFORMANCE

(76) Inventors: Scott Chabineau-Lovgren, Pomona, CA (US); Steve B. Sargeant, Anaheim Hills, CA (US); Mark A. Swart, Villa Park, CA (US)

Correspondence Address: CHRISTIE, PARKER & HALE, LLP, PO BOX 7068, PASADENA, CA, 91109-7068, US

(21) Appl. No.: 12/707,596

(22) Filed: Feb. 17, 2010

Related U.S. Application Data
(60) Provisional application No. 61/171,012, filed on Apr. 20, 2009.

(51) Int. Cl. H01R 4/48; H01R 43/16

(52) U.S. Cl. 439/817; 29/874

(57) ABSTRACT

A spring contact assembly having a first plunger with a tail portion having a flat contact surface and a swagable surface and a second plunger having a tail portion with a flat contact surface and a swagable surface wherein the flat contact surfaces are overlapping and are surrounded by an external compression spring such that the swagable surfaces are swaged by the coils of the spring during the initial compression of the spring.

### CROSS-REFERENCE TO RELATED APPLICATION(S)

This application claims priority to U.S. Provisional Application No. 61/171,012 filed Apr. 20, 2009.

### FIELD OF THE INVENTION

The present invention relates to electrical contact probes forming electrical interconnects and, more particularly, to a swaging process for form fitting a spring contact assembly having two movable and overlapping components surrounded by an external spring.

### BACKGROUND OF THE INVENTION

Conventional spring loaded contact probes generally include a movable plunger and a barrel having an open end for containing an enlarged diameter section of the plunger, and a spring for biasing the travel of the plunger in the barrel. The plunger bearing slidably engages the inner surface of the barrel. The enlarged bearing section is retained in the barrel by a crimp near the barrel open end. The plunger is commonly biased outwardly, a selected distance by the spring and may be biased or depressed inwardly into the barrel, a selected distance, under force directed against the spring. Axial and side biasing of the plunger against the barrel prevents false opens or intermittent points of no contact between the plunger and the barrel. The plunger generally is solid and includes a head or tip for contacting electrical devices under test. The barrel may also include a tip opposite the barrel's open end.

The barrel, plunger and tips form an electrical interconnect between the electrical device under test and test equipment and as such, are manufactured from an electrically conductive material. Typically the probes are fitted into cavities formed through the thickness of a test plate or socket. Generally a contact side of the electrical device to be tested, such as an integrated circuit, is brought into pressure contact with the tips of the plungers protruding through one side of the test plate or test socket for manufacturing spring pressure against the electrical device. A contact plate connected to the test equipment is brought to contact with the tips of the plungers protruding from the other side of the test plate or test socket. The test equipment transmits signals to the contact plate from where they are transmitted through the test probe interconnects to the device being tested. After the electrical device has been tested, the pressure exerted by the spring probes is released and the device is removed from contact with the tip of each probe.

The process of making conventional spring probes involves separately producing the compression spring, the barrel and the plunger. The compression spring is wound and heat treated to produce a spring of a precise size and of a controlled spring force. The plunger is typically turned on a lathe and heat treated. The barrels are also sometimes heat treated. The barrels can be formed in a lathe or by a deep draw process. All components may be subjected to a plating process to enhance conductivity. The spring probe components are assembled either manually or by an automated process.

An important aspect of testing integrated circuits is that they are tested under high frequencies. As such impedance matching is required between the test equipment and the integrated circuit so as to avoid attenuation of the high frequency signals. Considering that spacing within a test socket is minimal, in order to avoid attenuation of the high frequency signals, the length of the electrical interconnect formed by the probes must be kept to a minimum. To address this problem external spring probes have been developed having a shorter length than conventional probes. External spring probes consist of two separate sections each having a tip and a flange. A contact component extends from each probe section opposite the tip. The two contact components contact each other and the spring is sandwiched between two flanges that surround the contact components. Typically the first contact component is a barrel while the second contact component is a bearing surface. The bearing surface is slidably engaged to the inner surface of the barrel. These probes are fitted into cavities formed in the test sockets used during testing. A problem associated with these type of external spring probes is the expense to manufacture due to costly machining operations.

In response thereto external spring probes were designed having flat components which can be produced less expensively by stamping. Typically these designs incorporate two components which are connected orthogonally and the electrical path between the two components is through a protruding end surface. A problem with this design is that the components wear out rather quickly and have a short life span requiring constant replacement.

Non-orthogonally connected external spring contact assemblies have two movable and linearly overlapping contact members or plungers surrounded by an external spring. Each plunger has a contact portion and a tail portion wherein the tail portion has a flat surface that passes over and makes contact with an opposing flat plunger tail portion inside the spring when assembled. The spring has end coils that press onto each of the opposing plungers to prevent the plungers from separating from the spring, thus fixing the plunger contact portion and the tail portions with respect to each end of the spring. Utilizing the natural torsional movement of the spring while it is compressed, the flat surfaces of the plunger tail portions maintain contact throughout the compression stroke of the contact assembly. The contact between the opposing flat sections prevents the twisting or torsional movement of the spring from translating to the tips on the contact portions. The opposition to the natural twisting enhances the electrical conductivity of the components, which in turn improves performance of the spring contact assembly. The spring can also have reduced diameter coil sections along the length of the spring to further constrain the plunger tails and enhance the interaction between the two plungers, or further biasing effect can be created by adding an offset coil section in the spring.

Each of the plungers formed in a generally cylindrical shape are by lathe, screw machine or other similar manufacturing equipment. Plungers formed in a generally flat shape are by stamping, etching, photolithography or other similar manufacturing technique for creating substantially two dimensional geometries.

As stated, an important aspect of testing integrated circuits is that they are tested under high frequencies. High performance and high speed applications are very susceptible to resonance caused by the spring coils for compliant contacts having flat components. The interference caused by spring coil resonance in high performance, high speed, high frequency applications can negatively affect the resulting test signals. Consequently, a need exits for a method of manufacture of compliant electrical test contacts having flat components which prevents resonance and increases intimate contact force between components.

### SUMMARY OF THE INVENTION

The present invention is directed to an external spring contact assembly having two movable and overlapping contact members or plungers surrounded by an external spring and a method of manufacture which prevents unwanted resonance and increases intimate contact force between the components. Each plunger has a contact portion and a tail portion wherein the tail portion has a flat surface that passes over and makes contact with an opposing plunger tail portion inside the spring assembly. The spring has end coils that press on to each of the opposing plungers to prevent the plungers from separating from the spring.

Each of the plungers may be formed in a general cylindrical shape suitable for lathe, screw machine or other similar manufacturing equipment. The plunger may also be formed in a generally flat shape, suitable for stamping, etching, photolithography or other similar manufacturing technique for creating substantially two-dimensional geometries.

In order to prevent resonance and increase intimate contact force between components in compliant electrical test contacts, a form-fitting swaging process is incorporated in the manufacturing of the contact. Compliant contact components are designed to have a slight interference fit upon assembly. Initial swaging of the spring over the plunger and/or barrel deforms the interference features to produce a custom fit of the spring, plunger and/or barrel. As the compliant contact components are compressed for the first time, the interference between the spring deforms edges on the barrel or plunger components forming a custom and location or clearance fit. For screw machined components, the swagable portion is formed by relieving the diameter of a plunger so that it has one or more flat surfaces which reduces the surface of the diameter which can be swaged. For etched components, a cove feature provides an edge to be swaged during assembly. For stamped electroformed components, the swagable portion is formed by sharp corner portions which can be swaged during assembly.

These and other aspects of the present invention will be more fully understood with reference to the detailed description in combination with the drawings.

### BRIEF DESCRIPTION OF THE DRAWINGS

FIG. 1 is a perspective view of a spring contact assembly of the present invention;

FIG. 2 is a side view of a first plunger of the spring contact assembly of FIG. 1;

FIG. 3 is a side view of a spring of the spring contact assembly of FIG. 1;

FIG. 4 is a perspective of an alternative embodiment spring contact assembly of the present invention;

FIG. 5 is a side view of one plunger of the spring contact assembly of FIG. 4;

FIG. 6 is a cross-sectional view of the assembly of FIG. 4; and

FIG. 7 is a perspective view of an alternative embodiment spring contact assembly of the present invention.

### DETAILED DESCRIPTION OF THE INVENTION

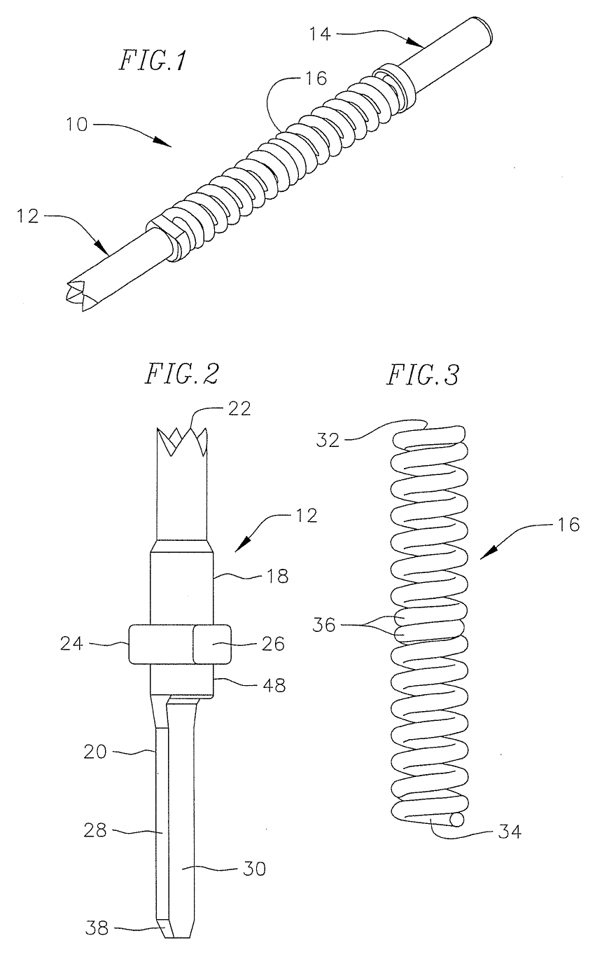

FIGS. 1-3 illustrate a first embodiment spring contact assembly 10 of the present invention. The spring contact assembly 10 includes a first contact member or plunger 12, a second contact member or plunger 14, and a spring 16. As shown in FIG. 2, plunger 12 includes a contact portion 18 and a tail portion 20. A contact tip 22 is positioned at an end of the contact portion 18 and can have multiple contact geometries. A flange 24 is positioned between contact portion or section 18 and tail portion or section 20. Flange 24 has a flat face 26 used for aligning the probe during assembly. The plunger tail portion 20 has a cylindrical surface 28 and a flat surface 30 extending along its length.

Plunger 14 also includes a contact portion and a tail portion. A flange is positioned between contact section and tail section and also includes a flat surface for positioning plunger 14 during assembly. Tail section has a cylindrical surface and a flat surface extending along its length. Flat surfaces pass over one another and make contact inside of spring 16 when assembled. Flat surfaces increasingly engage one another during compression of the assembly.

As shown in FIG. 3 the spring 16 has end coils 32 and 34 at opposite ends of the spring that press onto the plunger tail sections at the cylindrical sections adjacent the flanges. The end coils 32 and 34 may have a slightly smaller diameter and therefore firmly grip the cylindrical sections to prevent the plungers from separating from the spring. Utilizing the natural torsional movement of the spring 16 while it is compressed, the flat portions of the plungers maintain contact throughout the entire stroke of the probe. The contact between the opposing flat sections prevents twisting or torsional movement from translating it to the spring contact tips. The opposition to the natural twisting enhances the electrical conductivity of the components, which in turn improves the performance of the contact. To further constrain the tail sections and enhance the interaction between the two plungers, the spring 16 can employ reduced coil sections 36.

The tail section may have a reduced end section 38 that allows the spring to be threaded onto the tail portion before being press fit on the reduced diameter section adjacent the flange. The reduced section 38 allows the plunger to pilot into the spring, easing the assembly process. As previously indicated, the cylindrical sections of the plunger tails creates an interference fit with the end coils of the spring and the gripping force created between the cylindrical sections and the end coils is sufficient to keep the assembly together during normal handling and use and in combination with the flat surfaces resist normal torsional forces applied by the spring. The generally cylindrical plunger designs of FIGS. 1 and 2 are manufactured by machining such as a lathe, screw machine or other similar manufacturing equipment.

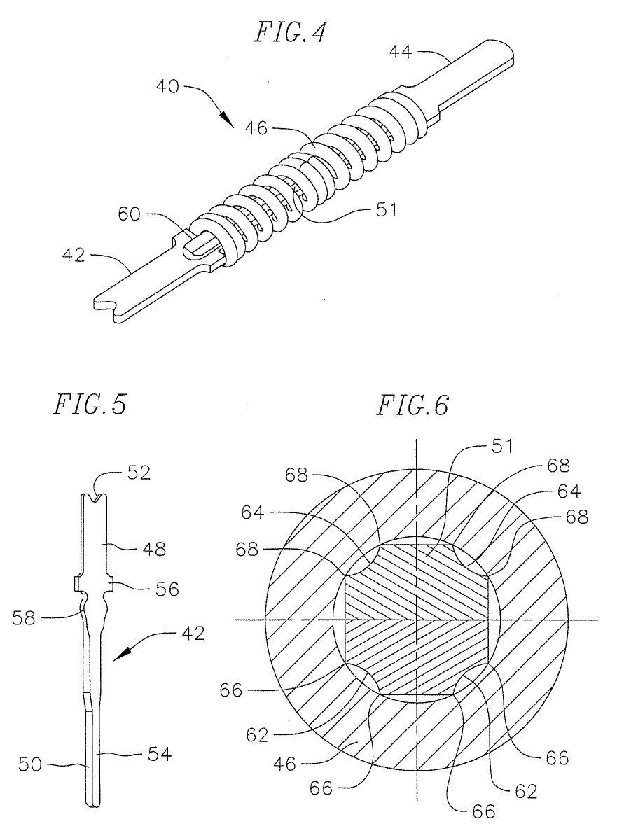

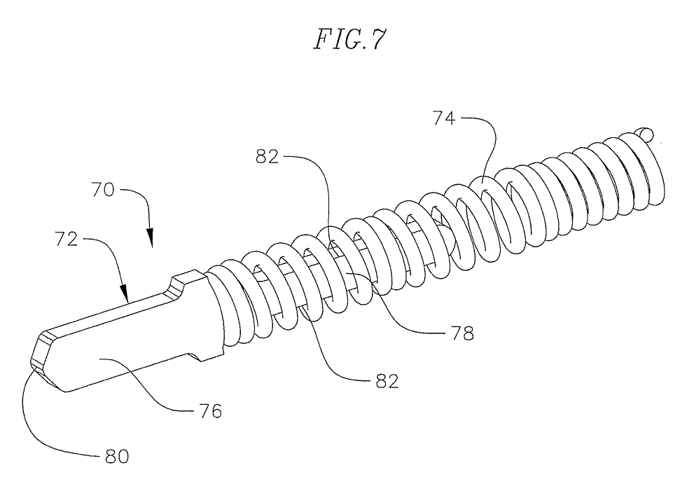

An alternative spring contact assembly 40 is illustrated in FIGS. 4-6. Spring contact assembly 40 includes two movable and overlapping plungers 42 and 44 surrounded by an external spring 46. Plungers 42 and 44 are formed in a generally flat shape, suitable for stamping, etching, photolithography or other similar manufacturing technique for creating substantially two-dimensional geometries.

Plunger 42 includes a contact portion or section 48 and a tail portion or section 50. Contact section 48 includes a contact tip 52 which can be any of a number of geometrical configurations. Considering the entire plunger has a flat configuration, plunger tail section 50 includes a flat surface 54. A flange 56 is positioned between contact section 48 and tail section 50. Tail section 50 includes an enlarged portion 58 for creating an interference fit with end coils of the spring 46 to retain the spring contact in its assembled configuration. Mating plunger 44 also includes a contact portion, a tail portion 51, and a flange positioned between the contact section and tail section. Tail section includes an enlarged portion for creating an interference fit with the end coils of spring 46.

In the flat configuration spring contact assembly 40, the plunger tail sections may have an end portion 60 that extends past the end coils of the spring as shown in FIG. 4. This design enhances the electrical contact between the plungers and adds support to the opposite plunger tip. One or both of the plunger tails can extend beyond the end coils for a particular application. As shown in FIG. 6, tail portions 50 and 51 have coves 62 and 64 along the edge of the outer surface which form cornices or points 66 and 68. In high performance testing applications where the spring contact assembly is susceptible to resonance caused by the spring coils under high frequency, intimate contact force is increased between plungers 42 and 44 and spring 46 by swaging the cornices or points 66 and 68 during initial assembly by the coils of spring 46. The swaging can be accomplished by reduced diameter end coils or center coil sections of the spring. The plungers are designed to have a slight interference fit upon assembly and the initial swaging of the spring over the plungers or barrel deforms interference features such as the cornices or points to produce a custom fit of the spring and the plungers or a barrel in applications including a barrel. As the compliant contacts are compressed for the first time, the interference between the spring deforms the edges forming a custom and location or clearance fit.

For cylindrical spring probes as shown in FIG. 1 the tail portion diameter is reduced to form a flat surface having edges that are swaged by the spring coils. For etched components as shown in FIG. 4, the cove 62 creates the edge points which are thin and unsupported and are ideal for swaging. Stamped or electroformed components are formed having sharp corners for the swaging process.

FIG. 7 illustrates an alternative embodiment spring contact assembly 70 comprising a single contact member or plunger 72 and a compression spring 74. Contact member 72 includes a contact portion 76 and a tail portion 78. A contact tip 80 is positioned at an end of the contact portion 76 and can have multiple contact geometries. Tail portion 78 has one or more swagable surfaces 82 positioned along an edge of the tail portion. As the tail portion 78 is inserted into the coils of springs 74, the edges are swaged to retain the spring on the contact member to control resonance of the contact assembly similar to the other embodiments. Although contact assembly 70 is illustrated having a contact member 72 having a flat configuration, it is to be understood that the contact member could also by cylindrical depending upon the particular application. The contact assembly shown in FIG. 7 is for applications requiring only a single contact member instead of two contact members as illustrated in the other embodiments.

Although the present invention has been described and illustrated with respect to several embodiments thereof it is to be understood that changes and modifications can be made therein which are within the full scope of the invention as hereinafter claimed.

What is claimed is:

1. A method of assembling a spring contact comprising the steps of:
forming a first contact having a swagable surface along an end portion of the first contact;
forming a second contact having a swagable surface along an end portion of the second contact;
inserting the end portion of the first contact having the swagable surface into a first end of a cylindrical coil spring;
inserting the end portion of the second contact having the swagable surface into an opposite end of the cylindrical coil spring; and
swaging the swagable surface of the first and second contacts within the coil spring to control resonance of the spring contact.

2. The method of claim 1 wherein the step of swaging is by compressing the first and second contacts towards one another within the spring.

3. The method of claim 1 wherein the step of forming a first contact having a swagable surface along an end portion is by relieving a diameter to produce at least one flat surface.

4. The method of claim 1 wherein the step of forming a first contact having a swagable surface comprises the step of etching a cove.

5. The method of claim 1 wherein the step of forming a first contact having a swagable surface comprises stamping a sharp corner.

6. A spring contact assembly comprising:
a first contact member having a tail portion having a flat contact surface along a length of the tail portion and a swagable surface along the length of the tail portion;
a second contact member having a tail portion having a flat contact surface along a length of the tail portion and a swagable surface along the length of the tail portion; and
a compression spring surrounding the first contact member tail portion and the second contact member tail portion,
whereby the swagable surface of the tail portion of the first contact member and the swagable surface of the tail portion of the second contact member are swaged by coils of the spring during initial compression of the spring.

7. The assembly of claim 6 wherein the spring includes reduced diameter end coils which engage the tail portions of the first and second contact members.

8. The assembly of claim 6 wherein the spring includes reduced diameter center coils which engage the tail portions of the first and second contact members.

9. The assembly of claim 6 wherein at least one of the first contact member and the second contact member is cylindrical and the swagable surface is a reduced diameter flat surface along the tail portion.

10. The assembly of claim 6 wherein at least one of the first contact member and the second contact member is a flat configuration in the swagable surface is a cornice formed by a cove along the tail portion.

11. The assembly of claim 6 wherein at least one of the first contact member and the second contact member is a flat configuration and the swagable surface is at least one sharp point formed along the tail portion.

12. A method of assembling a spring contact comprising the steps of:
forming a swagable surface along an edge portion of at least one contact;
inserting the contact having the swagable surface into a cylindrical coil spring; and
swaging the swagable surface within the coil spring to control the resonance of the spring contact.

13. The method of claim 12 wherein the step of swaging is by compressing the spring against the swagable surface.

14. The method of claim 12 wherein the step of forming the swagable surface is by relieving a diameter of an end portion of the contact to produce at least one flat surface.

15. The method of claim 12 wherein the step of forming the swagable surface is by etching a cover along an edge of the contact.

16. The method of claim 12 wherein the step of forming the swagable surface is by stamping a sharp corner along an edge of the contact.
